(19) United States
(12) Patent Application Publication
(10) Pub. No.: US 2005/0256789 A1
(43) Pub. Date: Nov. 17, 2005

(54) Real-time consolidated accounting systems and real-time consolidated accounting program

(75) Inventor: Hitoshi Matsuoka, Osaka City (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Information Planning Co., Ltd., Osaka-City (JP)

(21) Appl. No.: 11/127,148

(22) Filed: May 12, 2005

(30) Foreign Application Priority Data
May 17, 2004 (JP) 2004-146797

(51) Int. Cl. G06F 17/60

(52) U.S. Cl. 705/30

(57) ABSTRACT

The invention provides a real-time consolidated accounting system, by which consolidated accounting processing of the business group can be performed more accurately, and by which the consolidated financial position at any point in time can be grasped regardless of the closing date. When individual journal data, that corresponds to individual journals that are generated at respective companies belonging to the business group, is registered, the consolidated journal data preparation means prepares the journal data for consolidation based on that individual journal data. This journal data for consolidation is prepared so that the profit/loss of the parent company is expressed in accordance with the equity ratio when the account title code to be included in the individual journal data of affiliated companies is a profit/loss item. In this way, the consolidated financial statement data can be obtained using the journal data for consolidation prepared so as to correspond to the individual journal data relating to profittloss from affiliated companies.

### BACKGROUND OF THE INVENTION

1. Field of the Invention

This invention relates to a real-time consolidated accounting system and real-time accounting program that are used for preparing data for consolidated accounting or for preparing consolidated accounting documents.

2. Description of the Related Art

In recent years, in the settling of the accounts of a corporation (hereinafter, also referred to as “company”), a business group comprising corporations in a specific control relationship with that corporation is regarded as a single organizational body, and there is a heightening demand to prepare consolidated financial statements that comprehensively report the financial position and results of operation of that business group, and various consolidated accounting systems for that purpose have been proposed. Processing that has been performed in conventional consolidated accounting systems can be summarized as follows. (For example, Tomatsu Consulting Group “Design of a Consolidated Accounting System, published by CHUOKEIZAI-SHA, Inc., issued Jun. 5, 1997)

1) Collection of Base Data for Consolidation

The required materials and data from the parent company (referred to as the “consolidated company”, hereinafter the same) and affiliated companies (including subsidiaries (i.e. unconsolidated company) and equity method applied company (referred to as “related company”, hereinafter the same) is collected. The following can be presented as examples of required materials and data:

1-1) Account title data of parent company and affiliated companies

1-2) Individual accounting documents (financial statement) data of parent company and all affiliated companies

1-3) Asset/liability schedule data with the business group (including parent company and affiliated companies, hereinafter the same)

1-4) Schedule data of value of transactions within the business group

1-5) Schedule data of inventory purchased from within the business group

1-6) Purchase/sale data of securities, fixed assets, etc. within the business group

The data of 1) above is being obtained conventionally by preparing worksheets using spreadsheet software, etc., at each company, entering the above-mentioned data to those worksheets, collecting those results by recording media or electronic mail to enter to a parent company computer, entering data described in materials that have been sent from affiliated companies to the parent company computer, or sending/receiving data via a general-purpose or dedicated telecommunications line between the parent company computer and affiliated company computer.

2) Preparation of combined financial statements of parent company and affiliated companies

3) Offset elimination of parent company investment account and subsidiary common stock account

4) Offset elimination of assets/liabilities and value of transactions that have been generated within the business group

5) Posting of minority shareholders profit/loss and posting of equity earnings according to equity method

6) Unrealized profit elimination

7) Preparation of consolidated financial statements

Processing of 2) above onwards is performed based on the data of 1) above that has been collected at the parent company's year-end. FIG. 22 shows an example of actual processing. Looking from the left of the table in FIG. 22, data is journalized at each individual company during the term, financial statements are prepared individually at respective companies, and the data of those financial statements are combined (above processing 2)) to obtain the combined net income (=90). Following on from this, the part that corresponds to intercompany transactions is extracted, offset processing of this part is performed (processing 4)), minority shareholder equity and minority shareholder profit/loss is calculated with respect to the net income (=30) in the financial statements of subsidiaries, the equity earnings is posted (processing 5)) with respect to the net income (=60) in the financial statements of equity method applied companies (here, the equity ratio of subsidiaries of the parent company and equity method applied companies is assumed to be 0.8 and 0.2, respectively), and that is posted so that the consolidated financial statements are prepared. Unrealized profit elimination processing 6) is omitted.

Conventional processing, however, has the following problems.

1) When there are many affiliated companies, obtaining the data of all affiliated companies matched to the timing of settling of accounts at the parent company requires much time and trouble as tasks to be completed by the respective affiliated companies must be waited for, and the account title codes must be unified.

2) When the closing date of affiliated companies differs from the closing date of the parent company, accurate financial results of affiliated companies cannot be obtained. For this reason, measures such as use of affiliated company settlement data by a preset fixed time lag limit of 3 months, or use of provisional settlement data of the affiliated company up to the closing date of the parent company are adopted, and consolidated accounting based on accurate data cannot be performed.

3) Even if the equity ratio of subsidiaries has changed during the term, calculations are performed based on the year-end equity ratio, and consolidated accounting based on accurate data cannot be performed.

Up till now, the following proposals have been made for these problems.

For example, Japanese Patent Laid-Open 11-203373 discloses an art in relation to above-mentioned problem 2) in which a computer network, that has a database within the business group, is built to prevent receivables at one of the companies being posted while debt at another company is not posted in transactions within the business group; the billing company prepares billing data to transmit to the paying company, and the payment data is created at the paying company to transmit to the billing company; the billing company regards commercial transactions as having been established by means of the reception/transmission dates of the payment data; and commercial transactions within the business group established by a specified date are collected so that they can be eliminated individually.

Also, Japanese Patent Laid-Open 11-39409 discloses an art in relation to above-mentioned problem 1) in which transaction information that is generated within the business group is received/transmitted on computers between respective companies over a network though a server as a relay point, and at the same time is accumulated on the server; and the computers of respective affiliated companies are accessed to obtain off-balance information and financial accounting information of the respective companies, and obtain the transaction information accumulated in the server to prepare consolidated financial statements from these obtained information.

Furthermore, Japanese Patent Laid-Open 2001-84304 discloses an art in relation to above-mentioned problem 1) in which the account titles of respective affiliated companies are linked to group common account titles prepared by the parent company to solve differences in code tables and intricacies within the business group, and the required information is collected on a consolidated accounting center-installed device to perform consolidated accounting after having converted the trial balance sheet data specific to affiliated companies to a unified format and account title codes.

Moreover, Japanese Patent Laid-Open 2001-325419 discloses an art in relation to above-mentioned problems 1) and 2) in which the parent company and affiliated companies enter the consolidation codes at entry of journal data in the case of transactions within the business group; and companies whose closing date is different from that of the parent company prepare provisional settlement files, convert the account title codes between companies, and combine the balances for each account title is combined to perform consolidated elimination.

Each of the prior arts, however, is no more than settlement processing itself performing the processing in FIG. 22, and does not become a fundamental solution for the above-mentioned problems.

### SUMMARY OF THE INVENTION

The inventors have discovered a capability for solving the above-mentioned problems by fundamentally changing consolidated accounting processing that has been conventionally performed, and the purpose of this invention is to provide a real-time consolidated accounting system and real-time consolidated accounting program, by which consolidated accounting processing of the business group can be performed more accurately, and by which the consolidated financial position at any point in time can be grasped regardless of the closing date.

To solve the above-mentioned problems, a consolidated accounting system constituted by a computer, according to the present invention, comprises,
a storage unit configured to record equity ratio data for affiliated companies of a parent company,
a registration unit configured to register to the storage unit individual journal data of the parent company and affiliated companies that includes individually journalized dates, account title codes that enable recognition as to whether or not the code is a profit/loss item, amounts, debit and credit class, and consolidated company class data that indicates the relationship between the parent company and affiliated companies with respect to the parent company,
a consolidated journal data preparation unit configured to judge whether or not the account title code to be included in the individual journal data of an affiliated company is a profit/loss item, and, when the account title code is a profit/loss item, to prepare and register to the storage unit journal data for consolidation that includes date, account title code, amounts, and debit and credit class, using the above-mentioned equity ratio data from the individual journal data of the affiliated company,
whereby financial statement data at any time of combination is obtained by using amounts to be obtained by combining the above-mentioned journal data for consolidation by each account title code.

The consolidated journal data preparation unit can include an individual combination registration unit configured to prepare individual combination journal data having unified account titles for individual combination, corresponding to the individual journal data of the parent company and affiliated companies.

The consolidated journal data preparation unit can include a minority shareholder profit/loss posting unit configured to prepare minority shareholder profit/loss posting data that includes amount data, that is equivalent to the equity of minority shareholders with respect to individual profit/loss, corresponding to the individual journal data of a subsidiary whose account title code is a profit/loss item.

The consolidated journal data preparation unit can include an equity earnings posting unit configured to prepare equity earnings posting data that includes amount data, that is equivalent to the equity of the parent company with respect to individual profit/loss, corresponding to the individual journal data of an equity method applied company whose account title code is a profit/loss item.

The consolidated journal data preparation unit can include an asset/liabilities offset unit configured to prepare asset/liabilities offset data, whose debit and credit class for offsetting intercompany transactions is reversed, corresponding to the individual journal data that indicates intercompany transactions within the business group.

Financial statement data at any time of combination can be prepared based on amounts to be obtained by combining individual combination journal data, minority shareholder profit/loss posting data, equity earnings posting data, and asset/liabilities offset data by each account title.

The above-mentioned individual journal data can include consolidated company class data of the counterparty, and the above-mentioned consolidated journal data preparation unit can judge that the counterparty consolidated company class is the parent company, or an affiliated company or an outside company, and prepare asset/liabilities offset data, corresponding to individual journal data whose counterparty consolidated company class is the parent company or an affiliated company.

The above-mentioned equity ratio data can be recorded to the above-mentioned storage means together with a modification history, and the equity ratio data as of that date included in the individual journal data can be used for preparing journal data for consolidation.

Furthermore, a real-time consolidated accounting program according to the present invention, makes a computer function as
a storage means for storing equity ratio data for affiliated companies of a parent company,
a registration means for registering to the storage means individual journal data of the parent company and affiliated companies that includes individually journalized dates, account title codes that enable recognition as to whether or not the code is a profit/loss item, amounts, debit and credit class, and consolidated company class data that indicates a relationship between the parent company and affiliated companies with respect to the parent company,
an individual combination registration means for preparing individual combination journal data having unified account titles for individual combination, corresponding to the individual journal data of the parent company and affiliated companies,
a minority shareholder profit/loss posting means for preparing minority shareholder profit/loss posting data that includes amount data, that is equivalent to the equity of minority shareholders with respect to individual profit/loss, corresponding to the individual journal data of a subsidiary whose account title code is a profit/loss item,
an equity earnings posting means for preparing equity earnings posting data that includes amount data, that is equivalent to the equity of the parent company with respect to individual profit/loss, corresponding to the individual journal data of an equity method applied company whose account title code is a profit/loss item, and
an asset/liabilities elimination means for preparing asset/liabilities elimination data, whose debit and credit class for offsetting intercompany transactions is reversed, corresponding to the individual journal data that indicates intercompany transactions within the business group,
whereby financial statement data at any time of combination is prepared based on amounts to be obtained by combining the individual combination journal data, the minority shareholder profit/loss posting data, the equity earnings posting data, and the asset/liabilities offset data by each account title.

A consolidated accounting processing method according to the present invention that is performed using a computer, comprises
recording equity ratio data for affiliated companies of a parent company,
one of acquiring and preparing individual journal data of the parent company and affiliated companies that includes individually journalized dates, account title codes that enable recognition as to whether or not the code is a profit/loss item, amounts, debit and credit class, and consolidated company class data that indicates a relationship between the parent company and affiliated companies with respect to the parent company,
judging as to whether or not the account title code to be included in the individual journal data of an affiliated company is a profit/loss item, and, when the account title code is a profit/loss item, preparing the journal data for consolidation that includes date, account title code, amounts, and debit and credit class data, using the equity ratio data from the individual journal data of the affiliated company, and
preparing financial statement data at any time of combination using amounts to be obtained by combining the above-mentioned journal data for consolidation by each account title code.

The “account title code” to be included in the above individual journal data and journal data for consolidation shall refer to any of the item codes that are used in accounting processing, for example, item codes for P/L sheets, balance sheets, cash flow statements, and segment information. In the following embodiments, the account title code is expressed as item code, individual item code, consolidated item code, cash flow item code, and segment item code.

Also, “date” to be included in the above individual journal data and journal data for consolidation shall refer to any of the dates that are used for accounting processing, for example, accounting posting date and voucher entry date.

Again, “financial statement data” shall refer to any data that constitutes P/L sheets, balance sheets, cash flow statements, and segment information, for example.

Moreover, “individual journal data” may either be the data itself journalized and prepared respectively by the parent company or affiliated companies, or data obtained by further processing the said data, and is, in either case, data in which the content of vouchers journalized individually by respective company is indicated.

According to this invention, when individual journal data, that corresponds to individual journals that are generated at respective companies belonging to the business group, is registered, the consolidated journal data preparation means prepares the journal data for consolidation based on that individual journal data. This journal data for consolidation is prepared so that the profit/loss of the parent company is expressed in accordance with the equity ratio when the account title code to be included in the individual journal data of affiliated companies is a profit/loss item. In this way, the consolidated financial statement data can be obtained using the journal data for consolidation prepared so as to correspond to the individual journal data relating to profit/loss from affiliated companies.

In this way, the processing of “preparing journal data for consolidation from separate individual journal data” is not performed as up till now, and is based on a new concept. This processing can be performed not only at year-end but in real time during the term. Accordingly, by registering the individual journal data of affiliated companies in real time, there is no need to acquire the settlement data of affiliated companies, and the trouble of obtaining settlement data from affiliated companies matched to the timing of the settling of accounts at the parent company is no longer required.

Real-time consolidated accounting can be performed by registering the individual journal data of affiliated companies in real time to prepare journal data for consolidation from that individual journal data. Accordingly, there is no need to match the settlement date between the parent company and affiliated companies, nor is there the need to prepare provisional settlement data for affiliated companies, and accurate consolidated accounting can be performed.

Even supposing that the equity ratio of affiliated companies has changed during the term, accurate consolidated accounting can be performed by preparing journal data for consolidation by the equity ratio of that date to be included in the individual journal data.

Also, with respect to intercompany transactions, by including the consolidated company class data of the counterparty in the individual journal data, whether or not the transaction was generated within the business group can be judged, and transaction asset/liabilities offset processing can now be performed.

In this way, consolidated accounting processing can be performed more accurately, and the consolidated financial position of the business group at any point in time during the term can be grasped regardless of the settlement date. However, it goes without saying that this invention does not exclude to complete the consolidated processing using the settlement data for some companies, in the case of that it is impossible to register the individual journal data of those companies to be included in the business group, and only the settlement data of those companies can be obtained. It also goes without saying that, to complete consolidated processing, opening journal, unrealized profit elimination, etc. outside of interim processing as the main gist of this invention must be performed whenever necessary.

The present disclosure relates to subject matter contained in Japanese Patent Applications Nos. 2004-146797, filed on May 17, 2004, which is expressly incorporated herein by reference in its entirety.

### BRIEF DESCRIPTION OF THE DRAWINGS

The foregoing and other purposes, aspects and advantages will be better understood from the following detailed description of preferred embodiments of the invention with reference to the drawings, in which:

FIG. 1 is a block diagram of consolidated accounting system of this invention;

FIG. 2 is a drawing showing configuration of computer to be achieved by this consolidated accounting system;

FIG. 3 shows an example of configuration of company master;

FIG. 4A shows as example of configuration of account title master, FIG. 4B individual cash flow conversion master, and FIG.4C consolidated cash flow conversion master;

FIG. 5 shows a table indicating the correspondence between consolidated item codes and account title names;

FIG. 6 shows a table indicating the correspondence between account title master codes;

FIG. 7 shows a table indicating the relationship between account title codes and profit/loss items;

FIG. 8 shows an example of configuration of consolidated journal class master;

FIG. 9 shows an example of configuration of daily journal file;

FIG. 10A shows an example of configuration of monthly balance file, FIG. 10B cash flow balance file and FIG. 10C segmental balance file

FIG. 11 shows an example of voucher generated by subsidiary to be processed;

FIG. 12 is a flowchart of journal main processing;

FIG. 13 is a flowchart of consolidated registration processing;

FIG. 14 is a flowchart of individual journal registration processing;

FIG. 15 is a flowchart of individual combination registration processing;

FIG. 16 is a flowchart of minority shareholders profit/loss posting processing;

FIG. 17 is a flowchart of equity ratio acquisition processing;

FIG. 18 is a flowchart of equity method equity earnings posting processing;

FIG. 19 is a flowchart of asset/liabilities offset processing;

FIG. 20 is an explanatory drawing indicating the individual journal data and journal data for consolidation to be prepared by processing in FIGS. 12 to 19 for the voucher in FIG. 11;

FIG. 21 explanatory drawing illustrating the flow from data to be prepared by processing in FIGS. 12 to 19 up to preparation of the consolidated financial statement; and

FIG. 22 is an explanatory drawing illustrating conventional processing up to preparation of consolidated financial statement.

### DETAILED DESCRIPTION OF THE PREFERRED EMBODIMENTS

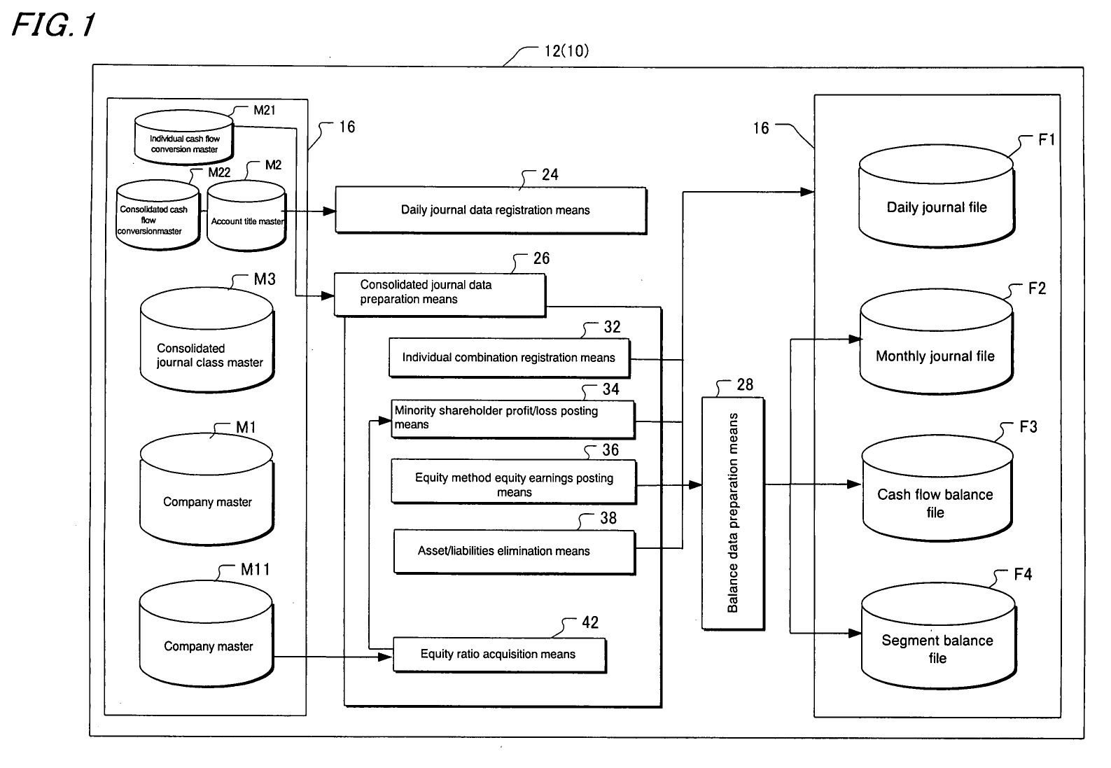

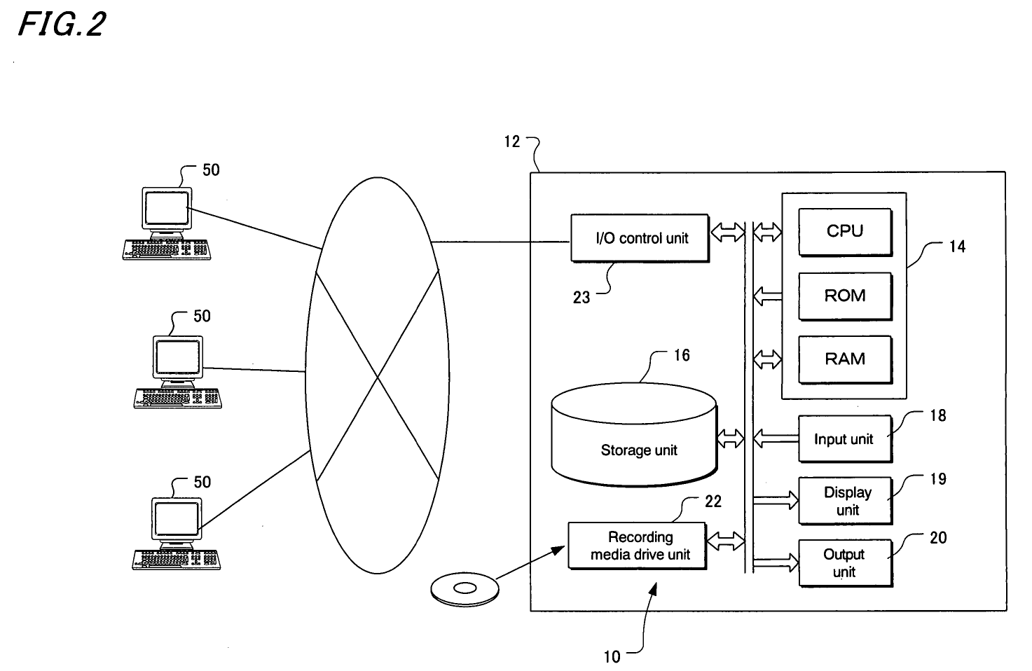

FIG. 1 shows a configuration of the computer by which consolidated accounting system 10 is achieved and that forms the consolidated accounting processing unit, and FIG. 2 is a block diagram thereof.

Computer 12 includes control circuit 14 having CPU, ROM, RAM, etc., for performing transfer of data, logic operations, temporary storage of data, and storage of the main program; storage unit 16 for performing data storage; input unit 18 for inputting various data; display unit 19 such as a CRT or LCD screen; output unit 20 such as a printer for performing writing to paper media; recording media drive unit 22 for performing reading and writing of magnetic, optical, and magneto-optical recording medium; and I/O control unit 23 for performing I/O of data with the outside.

Storage unit 16 of computer 12 and RAM of control unit 14 operate as the storage unit or storage means of consolidated accounting system 10. Note, however, that a storage unit physically integrated with computer 12 need not be the storage means of consolidated accounting system 10, which may be a storage unit equipped on a unit capable of being accessed from the control circuit of computer 12 via a transmission medium such as a network.

Computer 12 can also be configured as a server capable of being accessed from computers as multiple terminals via a telecommunications line. In this case, as shown in FIG. 2, individual data that has been input to terminal computer 50 at companies within the business group is transmitted via a dedicated or general-purpose telecommunications line.

Various data is stored to storage unit 16, and the masters and files described in detail later are as follows; company masters M1 and M11 for storing the data of companies belonging to the business group; account title master M2 in which, of the account title codes, the individual title codes that are used at each company, consolidated title codes to be used in common for consolidation, and segment title codes are linked, and that can recognize whether or not the said account title codes are profit/loss items; individual cash flow conversion master M21 and consolidated cash flow conversion master M22 in which, of the account title codes, the consolidated title codes and cash flow title codes are linked; consolidated journal class master M3 for storing the consolidated journal class codes; daily journal file F1 for storing the individual journal data from respective companies, and, at the same time, for storing the journal data for consolidation to be prepared based on that journal data; monthly balance file F2 for storing the monthly balance data; cash flow balance file F3 for storing the balance data of cash flows; segment balance file F4 for storing the balance data of segments; etc.,

Various programs are further stored on storage unit 16 of computer 12, and the consolidated accounting system according to this invention is achieved based on the consolidated accounting program therein. The consolidated accounting program that executes this processing makes computer 12 function, broadly speaking, as an input means (unit), to which journal data of companies belonging to the business group (hereinafter, called “input individual journal data”) is to be input, as daily journal data registration means (unit) 24 for registering individual journal data (hereinafter, called “registered individual journal data”) based on the input individual journal data, as consolidated journal data preparation means (unit) 26 for preparing the journal data for consolidation from individual journal data, and balance data preparation means (unit) 28 for preparing the balance data. From here on, unless needed to be recognized otherwise, both input individual journal data and registered individual journal data shall be referred to as “individual journal data.”

Consolidated journal data preparation means 26 can be divided into individual combination registration means (unit) 32 for preparing individual combination data with respect to individual journal data, minority shareholder profit/loss posting means (unit) 34 for preparing minority shareholder profit/loss posting data, equity method equity (investment) earnings posting means (unit) 36 for preparing equity earnings posting data, asset/liabilities elimination means (unit) 38 for preparing asset/liabilities elimination or offset data, and equity ratio acquisition means (unit) 42 for calculating the equity ratio of affiliated companies.

Next, the data to be used in consolidated accounting according to this invention are explained.

Company Master

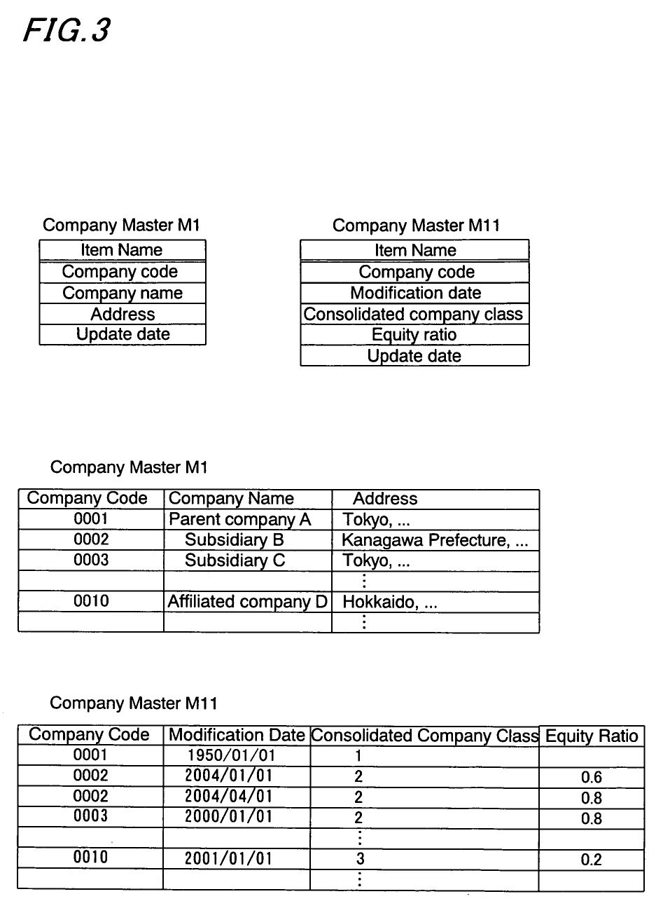

FIG. 3 shows the data to be stored to company master Ml and company master M11. The company code, company name and address that identify companies belong to the business group can be presented as examples of items to be set in single records in company master M1, and company code, modification date, consolidated company class, and equity ratio data can be presented as examples of items to be set in single records in company master M11. Here, “consolidated company class” is the code that expresses the relationship between companies including the own company belonging to the business group as viewed from the parent company of that company, namely, the relationship of parent company (i.e. own company), subsidiary, or equity method applied company. For example, the parent company is classified as consolidated company class=1, subsidiaries as consolidated company class=2, equity method applied companies as consolidated company class=3, and outside companies not belonging to the business group as consolidated company class=0. “Equity ratio” is an item that is input when the consolidated company class is 2 or 3, and is the equity ratio of that company of the parent company.

As the consolidated company class and equity ratio might change in real time even during the term, they are registered as separate records together with a modification date each time that they are modified. With this invention, though individual journal data is basically processed in real time, when, for example, individual journal data from affiliated companies is batch-processed, the consolidated company class and equity ratio as of that date that is to be included in the individual journal data can be known from the modification date.

Account Title Master

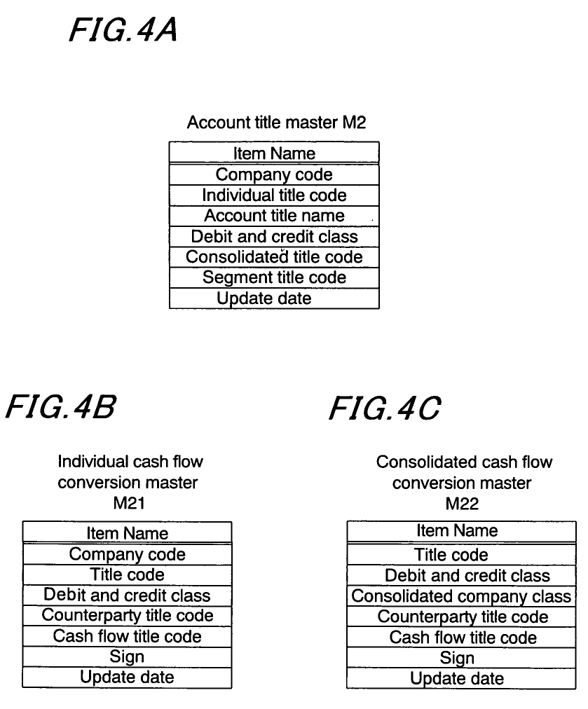

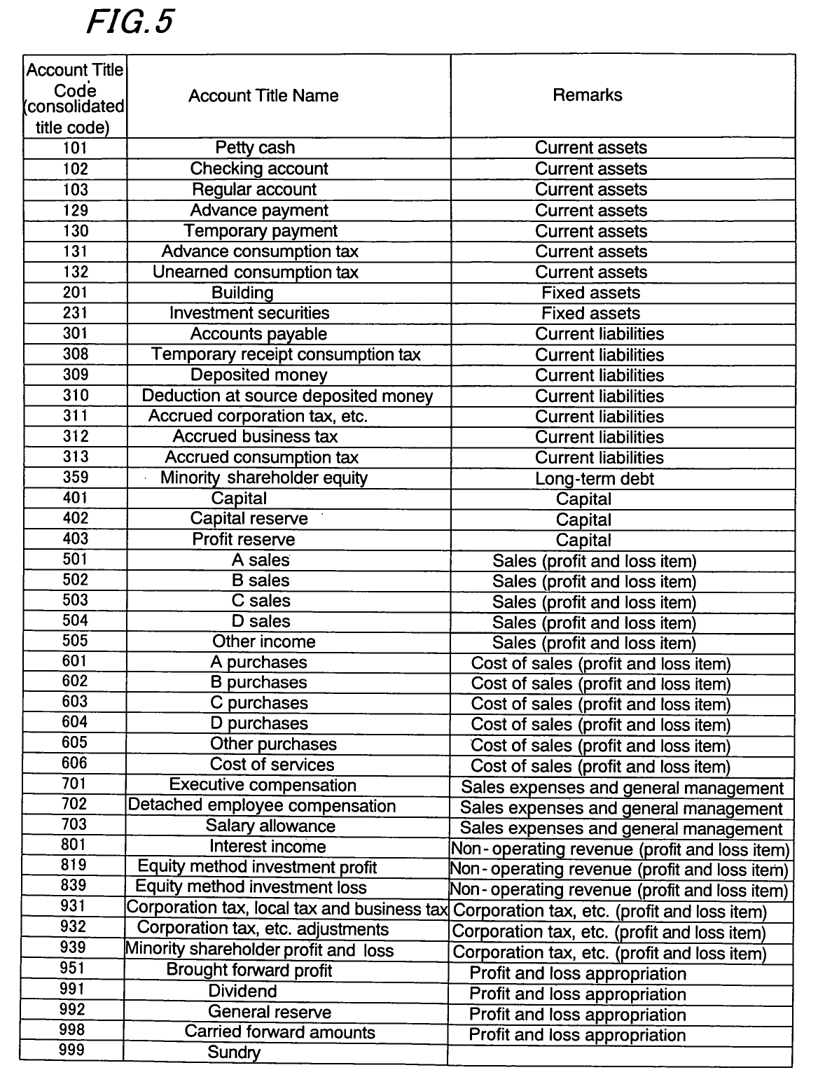

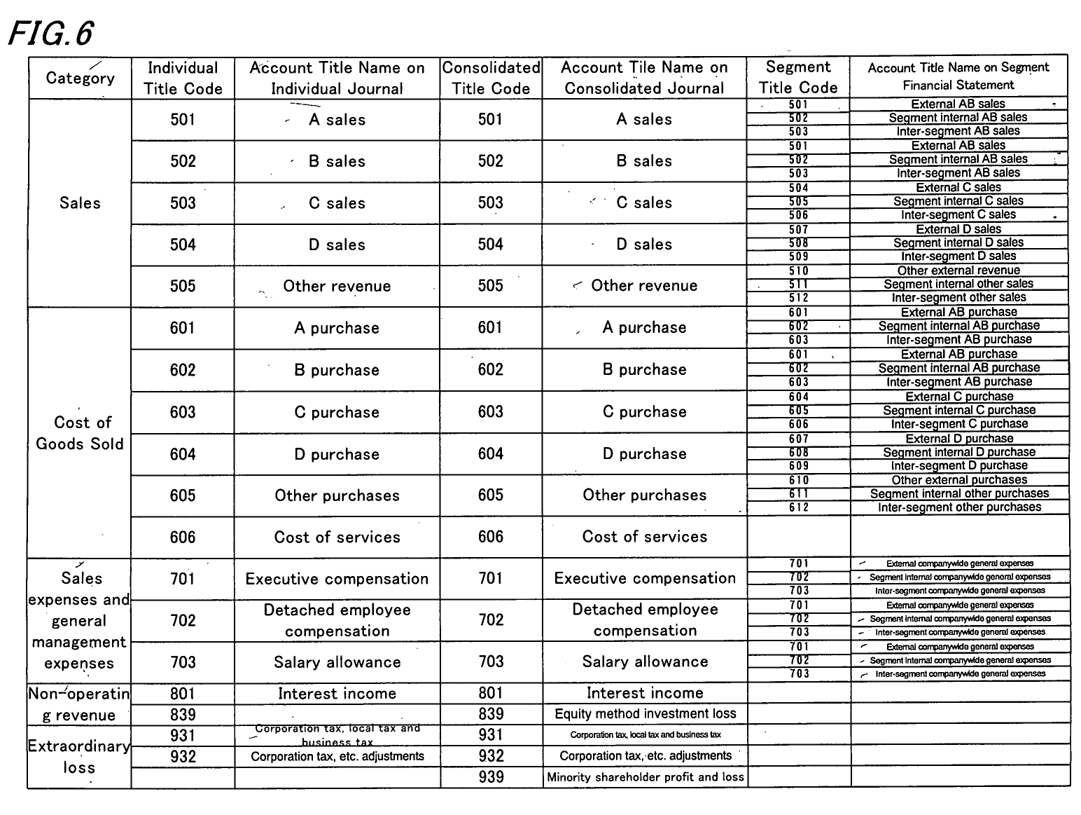

FIG. 4A shows the data to be stored to account title master M2. The company code, individual title code, account title name, debit and credit class, consolidated title code, and segment title code data can be presented as examples of items to be set to single records. As the account title code tables are diverse at respective companies, this account title master M2 is in the form of a correspondence table that is capable of converting the individual title codes of respective companies and common consolidated title codes. At the same time, it is also in the form of a correspondence table for performing the linking of title codes for performing segment consolidation. FIG. 5 is a table showing an example of correspondence between consolidated title codes and account title names, and FIG. 6 is a table showing an example of correspondence between some of the codes in account title master M2. In these examples, the individual title code is equal to the consolidated title code. It goes without saying that, at a business group, if the account title code table is common, then making this account title master M2 hold a linking function between individual title codes and consolidated title codes is not required.

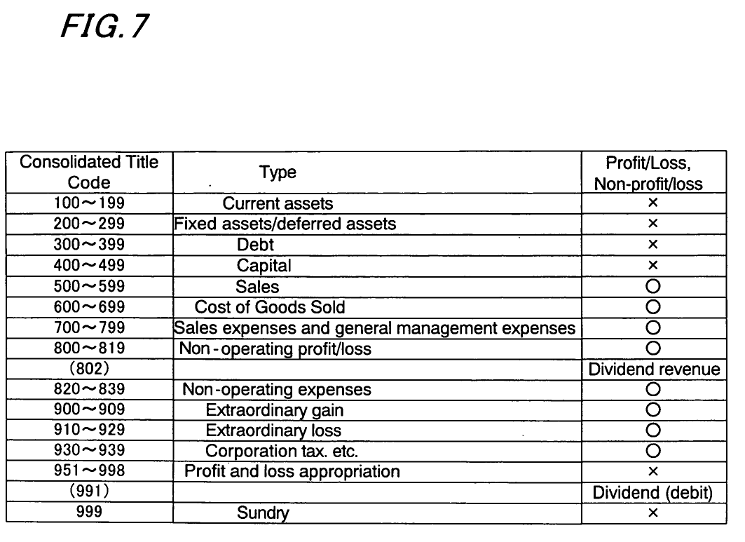

There are two account title codes, profit/loss items and non-profit/loss items. In consolidated accounting processing, recognition between profit/loss items and non-profit/loss items is important, and, in this embodiment, recognition as to profit/loss items or non-profit/loss items is possible by numbers assigned to common consolidated account codes. FIG. 7 is a table showing the relationship with those consolidated account codes as to whether or not they are profit/loss items. In the profit/loss and non-profit/loss row of the said table, o indicates a profit/loss item and x indicates a non-profit/loss item. Also, dividends received and dividends can be handled in a separate manner. Besides recognition by code numbers in this way, “profit/loss class” that performs recognition between profit/loss items and non-profit/loss items can also be set to account title master M2.

Cash Flow Conversion Master

FIGS. 4B and 4C show the data that is stored to individual cash flow conversion master M21 and consolidated cash flow conversion master M22. Individual cash flow conversion master M21 is obtained by linking the respective codes for calculating the cash flow title codes, that are used for preparing individual cash flow statements, from the combinations of title codes, debit and credit class, and counterparty title codes. Consolidated cash flow conversion master M22 is obtained by linking the respective codes for calculating the cash flow title codes, that are used for preparing consolidated cash flow statements, from the combinations of title codes, debit and credit class, consolidated company class, and counterparty title codes. Of the items, “sign” is for recognizing whether the sign of amounts in cash flow statements is to be expressed as plus or minus.

Consolidated Journal Class Master

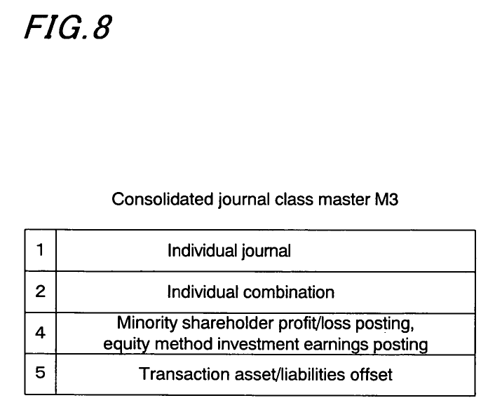

FIG. 8 shows the data to be stored to consolidated journal class master M3. Consolidated journal code and code name are available as items to be set to single records. This consolidated journal code is used for classifying several kinds of the journal data for consolidation for multiple consolidated processing to be prepared for individual journal data that has been input in processing on the program, and the function of the consolidated journal code shall be described later. It is not mandatory that the “consolidated journal code” be saved on storage unit 16 in the form of a consolidated journal class master.

Daily Journal File

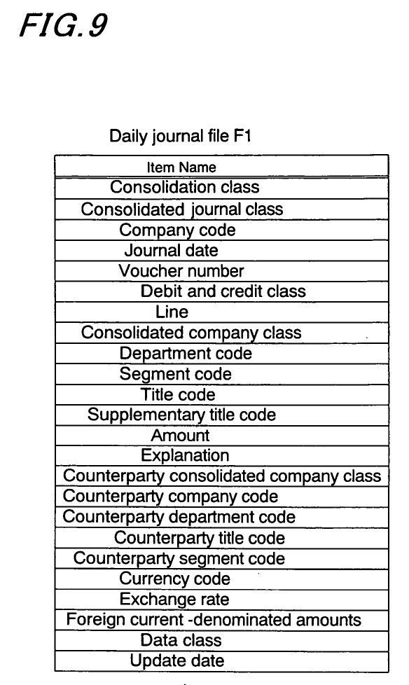

FIG. 9 shows the data to be stored to daily journal file F1. Consolidation class, consolidated journal class, company code, date, voucher number, debit and credit class, line, consolidated company class, department code, segment code, title code, supplementary items, amounts, explanations, counterparty consolidated company class, counterparty company code, counterparty department code, counterparty title code, counterparty segment code, currency code, exchange rate, foreign currency-denominated amounts, etc. can be presented as examples of items to be set to single records.

The individual journal data of respective companies and the journal data for consolidation that has been prepared for consolidation processing are stored to daily journal file F1. For this reason, whether that record is individual journal data or journal data for consolidation is classified by the “consolidation class”. For example, the consolidation class is set as “0” in the case of individual journal data, and as “1” in the case of journal data for consolidation. Also, as described later, individual combination journal data, minority shareholder profit/loss posting data, equity method equity earnings posting data, and minority shareholder profit/loss posting data relating to transaction eliminations are available as journal data for consolidation, and these are classified by the consolidated journal code defined in consolidated journal class master M3 shown in FIG. 8. The “debit and credit” class classifies whether a transaction is a debit or credit, and is, for example, set as “0” for debits and as “−1” for credits. “Line” corresponds to the number of lines of the journal. The consolidated company class of the company that generated the voucher corresponding to that journal data is entered to “consolidated company class”. On the other hand, at “counterparty consolidated company class”, the consolidated company class of the counterparty of the transaction corresponding to that voucher is input. At “counterparty company code”, the company code of the counterparty when the counterparty of the transaction is a company belonging to the business group is input.

Monthly Balance File, Cash Flow Balance File, Segment Balance File

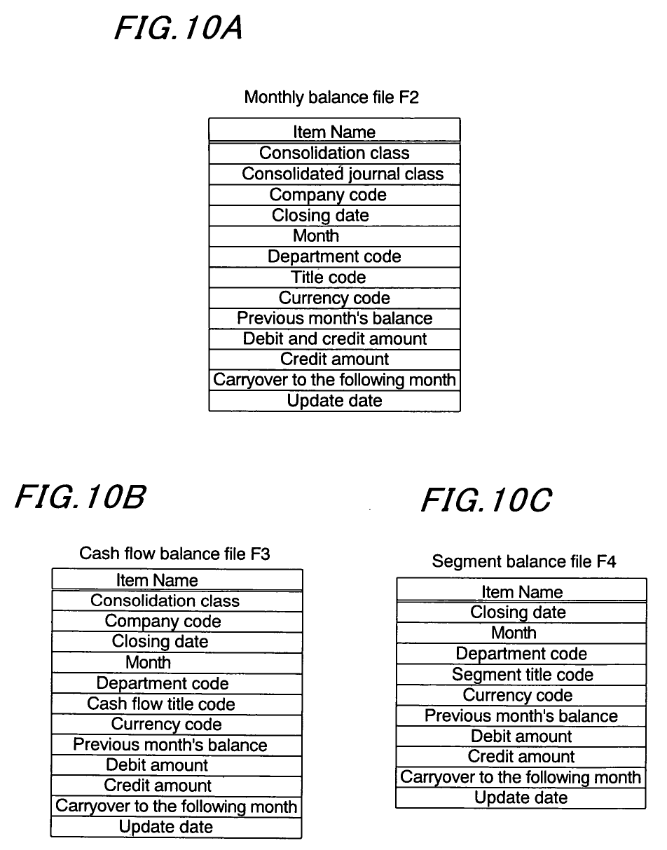

FIG. 10 shows the data that is stored to monthly balance file F2, cash flow balance file F3, and segment balance file F4. Consolidation class, consolidated journal class, company code, book-closing period, month, department code, consolidated title code, currency code, previous month's balance, debit amounts, credit amounts, carryover to the following month, etc. can be presented as examples of items to be set in single records.

Operations

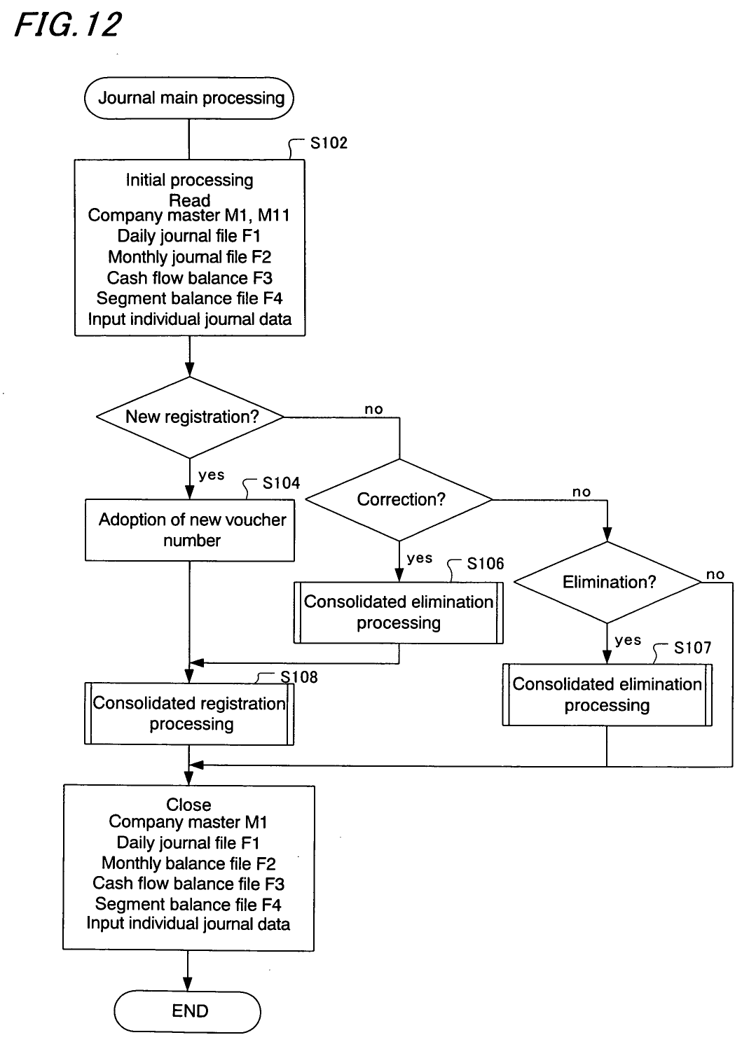

Now, the operation of each means is explained while referring to the flowcharts in FIGS. 12 to 19 that show consolidated accounting processing.

First of all, FIG. 12 is a flowchart showing journal main processing. As the initial processing, company masters M1 and M11, daily journal file F1, monthly balance file F2, cash flow balance file F3, and segment balance file F4 is read, and the input individual journal data that has been input (S102).

Moreover, in the case of new registration of individual journal data, a new voucher number is adopted (S104), and processing advances to the consolidation deletion processing sub-routine in the case of correction or deletion of individual journal data (S106, S107), and to the consolidated registration processing sub-routine in the case of new registration or correction (S108).

Here, the input individual journal data is input to computer 12 by a telecommunications line, recording medium or manual input in real time from companies belonging to the business group that is currently targeted, and after input is stored temporarily to RAM.

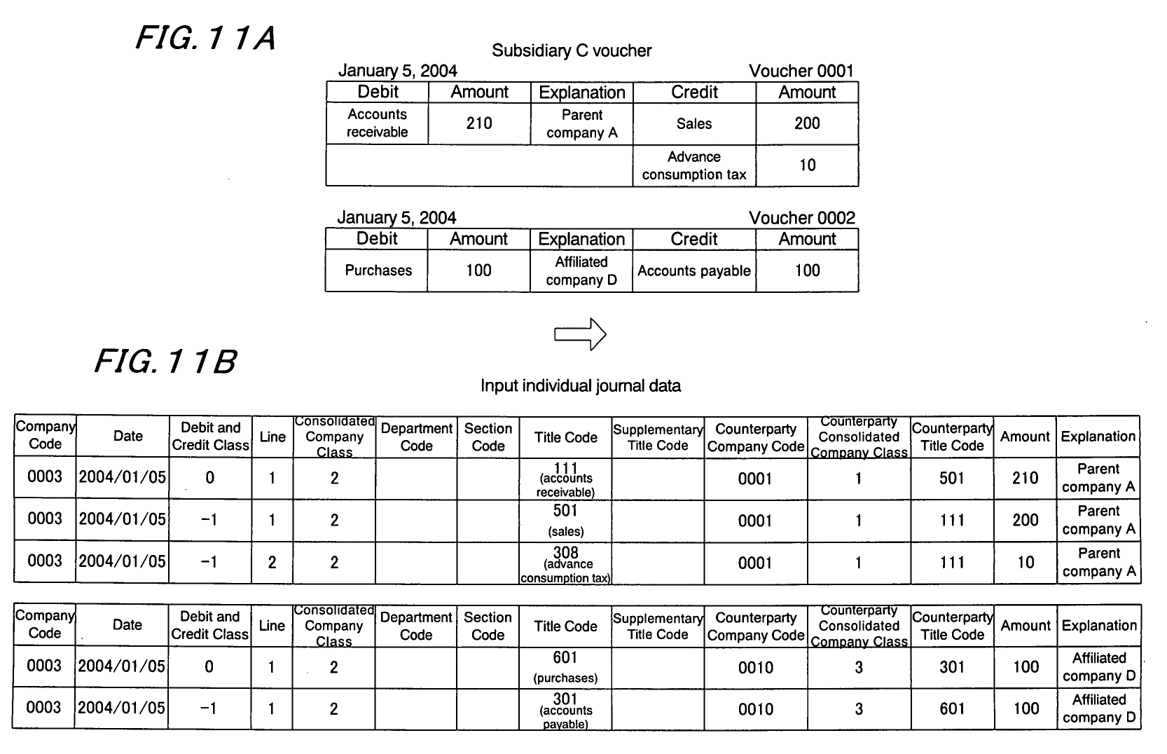

Now, let us consider processing of the two vouchers shown in FIG. 11A. In this example, with the first of these vouchers, voucher 0001, the sale was posted by one of the subsidiaries, subsidiary C, with parent company A as the counterparty, and by the second of these vouchers, voucher 0002, the purchase was performed by subsidiary C with affiliated company D, an equity method applied company. In this case, as shown in FIG. 11B, the 1st input individual journal data is input in the form of three records each divided into credits and debits, and the 2nd input individual journal data is input to computer 12 in the form of two records. In FIG. 11B, attention should be paid to the fact that company code “0003” indicates subsidiary C; in the 1st input individual journal data, consolidated company class “2” indicates a subsidiary, counterparty company code “0001” indicates parent company A, and counterparty consolidated company class “1” indicates the parent company; and, in the 2nd input individual journal data, consolidated company class “2” indicates a subsidiary, counterparty company code “0010” indicates affiliated company D, and counterparty consolidated company class “3” indicates the equity method applied company.

Note, however, that at the stage when input individual journal data has been acquired from respective companies, code tables unique to respective companies might be in use, or might be lacking as information for the above company codes, and consolidated company class and counterparty consolidated company class, and so code conversion or code addition shall be performed at data input.

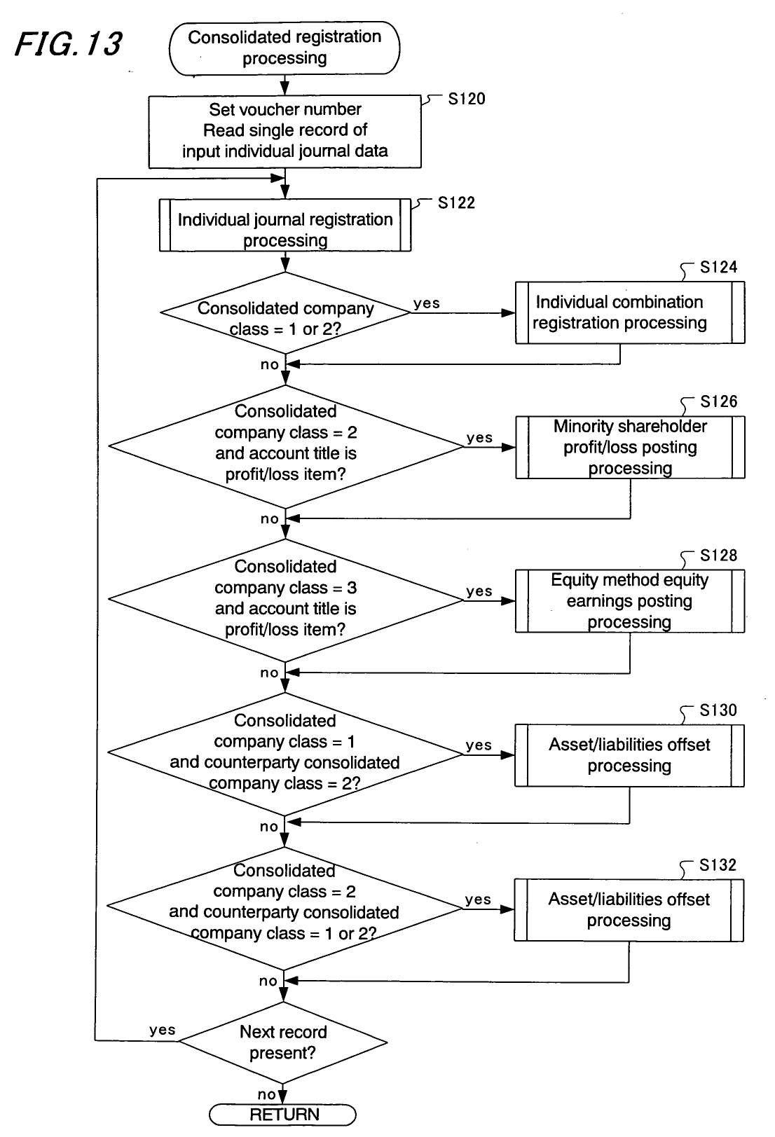

The input individual journal data that has been input is supplied to processing by the consolidated registration processing sub-routine indicated in FIG. 13 onwards.

Individual Journal Registration Processing

In FIG. 13, as the initial processing, after the voucher number is set, and one of the input individual journal records of the input individual journal data is read (S120), individual journal registration processing (S122) is performed by daily journal data registration means 24.

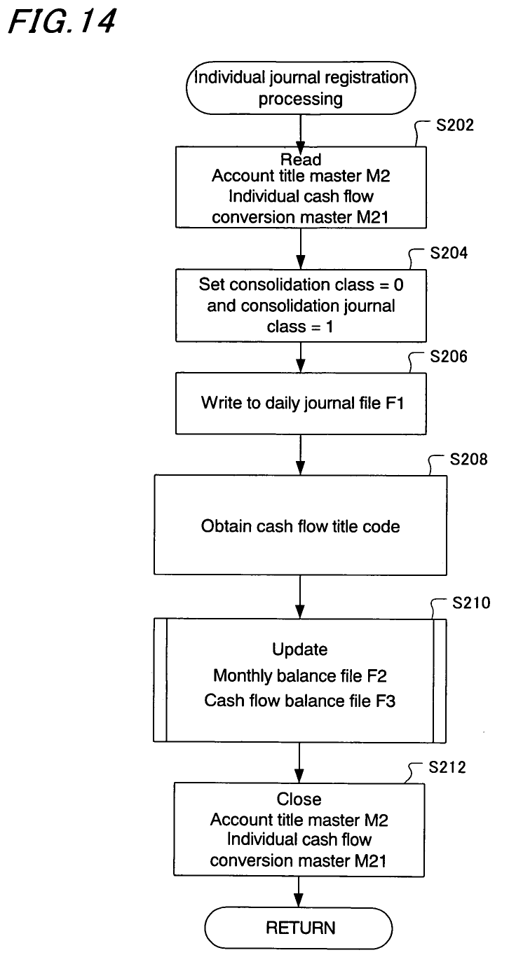

As shown in FIG. 14, as the initial processing, daily journal data registration means 24 reads account title master M2 and individual cash flow conversion master M21 (step S202), then sets “0” as the consolidation class and “1” as the consolidated journal class, and writes (step S206) to daily journal file F1 taking these classes that have been set and the input individual journal data currently being processed as a single record. Then, account title master M2 and individual cash flow conversion master M21 are looked up to obtain (step S208) the cash flow title code corresponding to the combination of the individual title code, debit and credit class, and counterparty title code, to recalculate each of the balances of monthly balance file F2 and cash flow balance file F3, and the new balance is written to them (step S210). Finally, account title master M2 and individual cash flow conversion master M21 are closed (step S212), and processing returns to FIG. 13.

In short, processing by daily journal data registration means here enables recognition that the input individual journal data from respective companies is individual (that is, consolidation class=0, consolidated journal class=1), and registers the input individual journal data to daily journal file F1 as registered individual journal data.

Individual Combination Registration Processing

Next, returning to FIG. 13, when the consolidated company class of the input individual journal data currently being processed is “1” or “2”, individual combination registration processing is performed (S124) by individual combination registration means 32 of consolidated journal data preparation means 26.

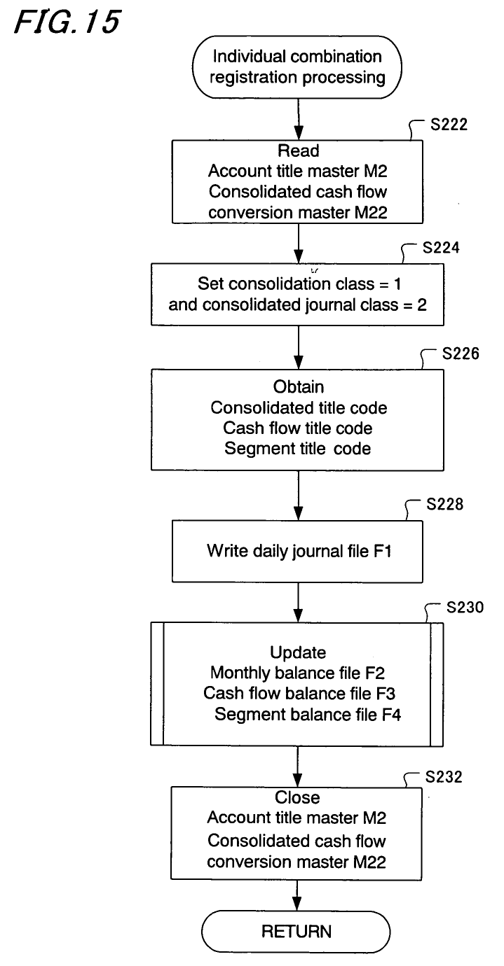

As shown in FIG. 15, as the initial processing, individual combination registration means 32 reads account title master M2 and consolidated cash flow conversion master M22 (step S222), and then sets “1” as the consolidation class and “2” as the consolidated journal class (step S224). Then, account title master M2 is looked up to obtain the consolidated title code corresponding to the individual title code, to obtain the segment title code from combination of the individual title code, segment code and counter segment codes, and the account title master M2 and the consolidated cash flow conversion master M22 are looked up to obtain (step S226) cash flow title code corresponding to the combination of the individual title code, debit and credit class, consolidated company class, and counterparty title code. Then, the individual combination journal data, that takes the result of having substituted individual title codes to be included in the input individual journal data currently being processed with consolidated title codes as a single record together with the above-mentioned classes that have been set, is written (step S228) to daily journal file F1. Then, each of the balances of monthly balance file F2, cash flow balance file F3, and segment balance file F4 are re-calculated, and the new balances are written to them (step S230). Finally, account title master M2 and consolidated cash flow conversion master M22 are closed (step S232), and processing returns to FIG. 13.

In short, processing by individual combination registration means 32 in consolidated journal data preparation means 26 here converts the individual title codes in the input individual journal data of the parent company and subsidiaries to common consolidated title codes as necessary, and at the same time enables recognition that the converted data is individual combination journal data for individual combination so that it is registered to daily journal file F1. As the individual journal data of equity method applied companies is not combined, individual combination journal data is not prepared for input individual journal data of equity method applied companies.

Minority Shareholder Profit/Loss Posting Processing

Next, returning to FIG. 13, when the account title of the input individual journal data currently being processed is a profit/loss item, and the consolidated company class is “2”, minority shareholders profit/loss posting processing is performed (S126) by minority shareholder profit/loss posting means 34.

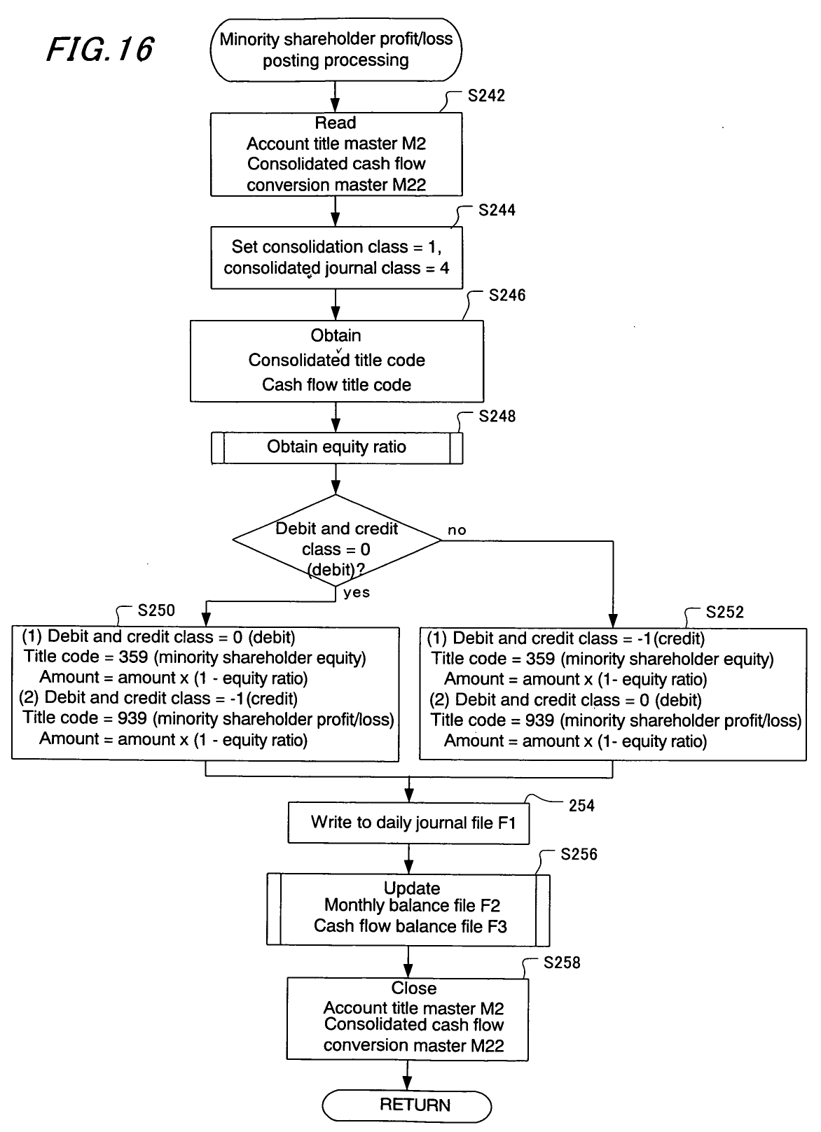

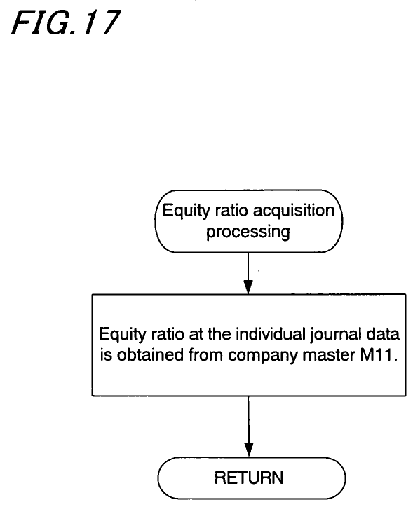

As shown in FIG. 16, as the initial processing, minority shareholder profit/loss posting means 34 reads account title master M2 and consolidated cash flow conversion master M22 (step S242), and then sets “1” as the consolidation class and “4” as the consolidated journal class (step S244). Then, account title master M2 is looked up to obtain the consolidated title code corresponding to the individual title code, and account title master M2 and consolidated cash flow conversion master M22 are looked up to obtain (step S246) the cash flow title code corresponding to combination of the individual title code, debit and credit class, consolidated company class, and counterparty title code. Next, processing advances (step S248) to equity ratio acquisition processing shown in FIG. 17.

As shown in FIG. 17, equity ratio acquisition processing means 42 looks up company master M11 to obtain the equity ratio as of that date to be included in the input individual journal data. As the history of the equity ratio is managed by company master M11, the relationship between date and equity ratio can now be precisely linked.

Next, returning to FIG. 16, the minority shareholder profit/loss posting data is prepared. In actual terms, when the debit and credit class of the input individual journal data currently being processed is debit (corresponding to records whose title in FIG. 11 B is purchases (title code=601)), the following logic operation is performed (step S250).

(i) Debit and credit class=0 (debit)
Title code=359 (minority shareholder equity)
Amount=amount×(1−equity ratio)
(ii) Debit and credit class=−1 (credit)
Title code=939 (minority shareholder profit/loss)
Amount=amount×(1−equity ratio)

On the other hand, when the debit and credit class of the input individual journal data currently being processed is credit (corresponding to records whose title in FIG. 11B is sales (title code=501)), the following logic operation is performed (step S252).

(i) Debit and credit class=−1 (credit)
Title code=359 (minority shareholder equity)
Amount=amount×(1−equity ratio)
(ii) Debit and credit class=0 (debit)
Title code=939 (minority shareholder profit/loss)
Amount=amount×(1−equity ratio)

The minority shareholder profit/loss posting data, that takes the result of having substituted the debit and credit class, individual title codes and amounts to be included in the input individual journal data currently being processed with above-mentioned (i) and (ii) as a single record together with the above-mentioned classes that have been set, is written (step S254) to daily journal file F1. Then, each of the balances of monthly balance file F2 and cash flow balance file F3 are re-calculated, and the new balances are written to them (step S256). Finally, account title master M2 and consolidated cash flow conversion master M22 are closed (step S258), and processing returns to FIG. 13. In short, processing by minority shareholder profit/loss posting means 34 in consolidated journal data preparation means 26 here enables the individual posting of the equity of minority shareholders other than the parent company and of the profit/loss of minority shareholders corresponding thereto with respect to the input individual journal data relating to individual profit/loss that is generated at subsidiaries, and the recognition of that as minority shareholder profit/loss posting data (that is, consolidated journal class=4) to add the minority shareholder profit/loss posting data to daily journal file F1.

Equity Method Equity Earnings Posting Processing

Next, returning to FIG. 13, when the account title of the input individual journal data currently being processed is a profit/loss item, and the consolidated company class is “3”, equity method equity earnings posting processing is performed (S128) by equity method equity earnings posting means 36.

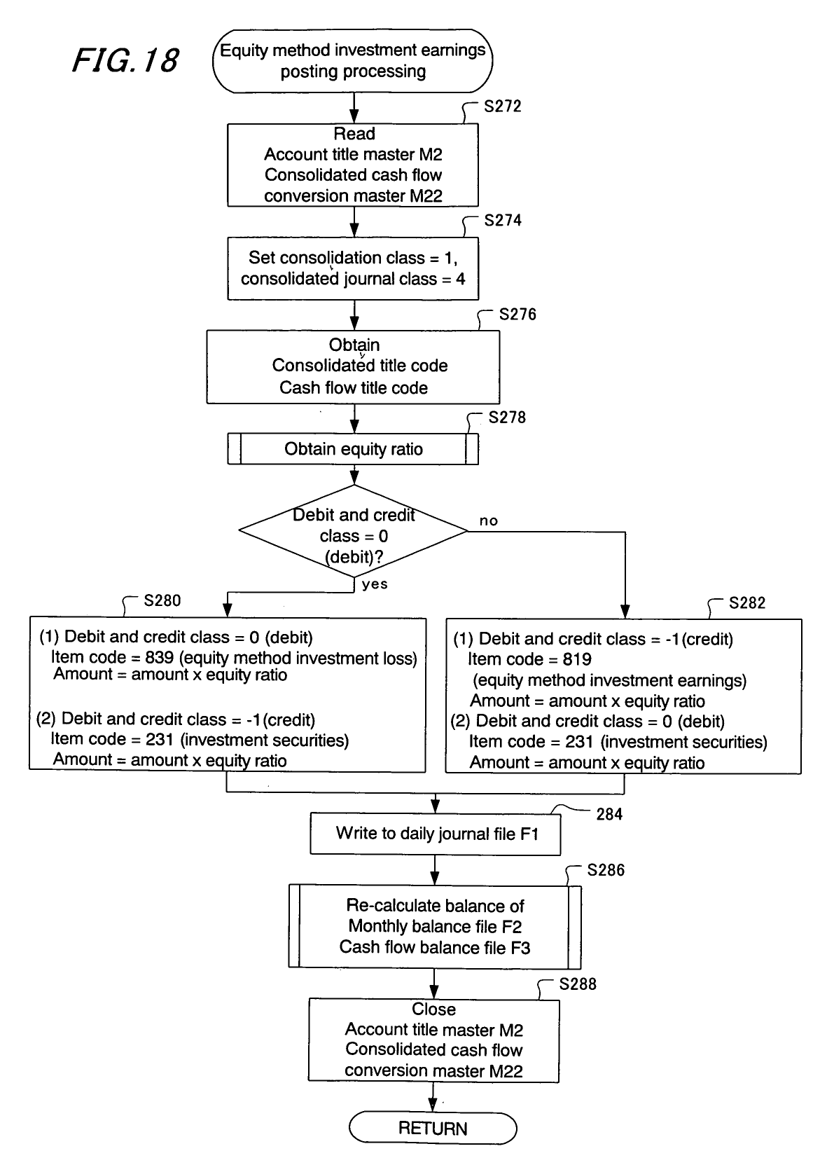

As shown in FIG. 18, as the initial processing, equity method equity earnings posting means 36 reads account title master M2 and consolidated cash flow conversion master M22 (step S272), and then sets “1” as the consolidation class and “4” as the consolidated journal class (step S274). Then, account title master M2 is looked up to obtain the consolidated title code corresponding to the individual title code, and account title master M2 and consolidated cash flow conversion master M22 are looked up to obtain (step S276) the cash flow title code corresponding to combination of the individual title code, debit and credit class, consolidated company class, and counterparty title code. Next, processing advances to equity ratio acquisition processing shown in FIG. 17, and the equity ratio is acquired (step S278).

Next, the equity method equity (investment) earnings posting data is prepared. In actual terms, when the debit and credit class of the input individual journal data currently being processed is debit, the following logic operation is performed (step S280).

(i) Debit and credit class=0 (debit)
Item code=839 (equity method investment loss)
Amount=amount×equity ratio
(ii) Debit and credit class=−1 (credit)
Item code=231 (investment securities)
Amount=amount×equity ratio

On the other hand, when the debit and credit class of the input individual journal data currently being processed is credit, the following logic operation is performed (step S282).

(i) Debit and credit class=−1 (credit)
Item code=819 (equity method investment earnings)
Amount=amount×equity ratio
(ii) Debit and credit class=0 (debit)
Item code=231 (investment securities)
Amount=amount×equity ratio

The equity method investment earnings posting data, that takes the result of having substituted the debit and credit class, individual title codes and amounts to be included in the input individual journal data currently being processed with above-mentioned (i) and (ii) as a single record together with the above-mentioned classes that have been set, is written (step S284) to daily journal file F1. Then, each of the balances of monthly balance file F2 and cash flow balance file F3 are re-calculated, and the new balances are written to them (step S286). Finally, account title master M2 and consolidated cash flow conversion master M22 are closed (step S288), and processing returns to FIG. 13.

In short, processing by equity method equity earnings posting means 36 in consolidated journal data preparation means 26 here enables the individual posting of the profit/loss corresponding to the equity ratio of the parent company with respect to the input individual journal data relating to individual profit/loss that is generated at equity method applied companies, and the recognition of that as equity method investment earnings posting data (that is, consolidated journal class=4) to add the equity method investment earning posting data to daily journal file F1.

Transaction Asset/Liabilities Offset Processing

Next, returning to FIG. 13, when the consolidated company class of the individual journal data currently being processed is “1” and the counterparty consolidated company class is “2”, transaction asset/liabilities offset processing is performed (S130) by asset/liabilities offset processing means 38.

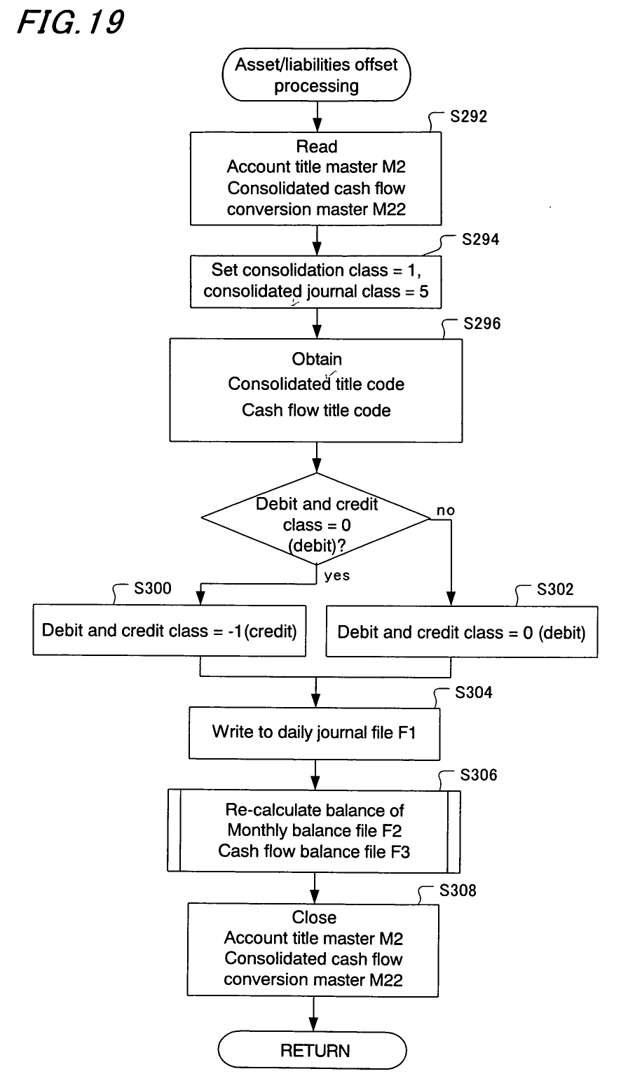

As shown in FIG. 19, as the initial processing, asset/liabilities offset processing means 38 reads account title master M2 and consolidated cash flow conversion master M22 (step S292), and then sets “1” as the consolidation class and “5” as the consolidated journal class (step S294). Then, account title master M2 is looked up to obtain the consolidated title code corresponding to the individual title code, and account title master M2 and consolidated cash flow conversion master M22 are looked up to obtain (step S296) the cash flow title code corresponding to combination of the individual title code, debit and credit class, and consolidated company class, counterparty title code.

Moreover, the asset/liabilities record is prepared. In actual terms, when the debit and credit class of the input individual journal data currently being processed is debit, “−1” (credit) is set as the debit and credit class (step S300), and alternately, when the debit and credit class of the input individual journal data currently being processed is credit, “0” (debit) is set as the debit and credit class (step S300).

The asset/liabilities data, that takes the result of having substituted the debit and credit class to be included in the input individual journal data currently being processed as a single record together with the above-mentioned classes that have been set, is written (step S304) to daily journal file F1. Then, each of the balances of monthly balance file F2 and cash flow balance file F3 are re-calculated, and the new balances are written to them (step S306). Finally, account title master M2 and consolidated cash flow conversion master M22 are closed (step S308), and processing returns to FIG. 13.

In short, processing by asset/liabilities offset processing means 38 in consolidated journal data preparation means 26 here prepares the asset/liabilities offset data, that holds the opposite debit and credit class of the input individual journal data corresponding to intercompany transactions, to add the data to daily journal file F1 so that intercompany transactions within the business group are offset.

Next, returning to FIG. 13, when the consolidated company class of the individual journal data currently being processed is “2” and the counterparty consolidated company class is “1” or “2”, asset/liabilities offset processing is performed by asset/liabilities offset processing means 38. A description of this processing is omitted as it is the same as the processing shown in FIG. 19.

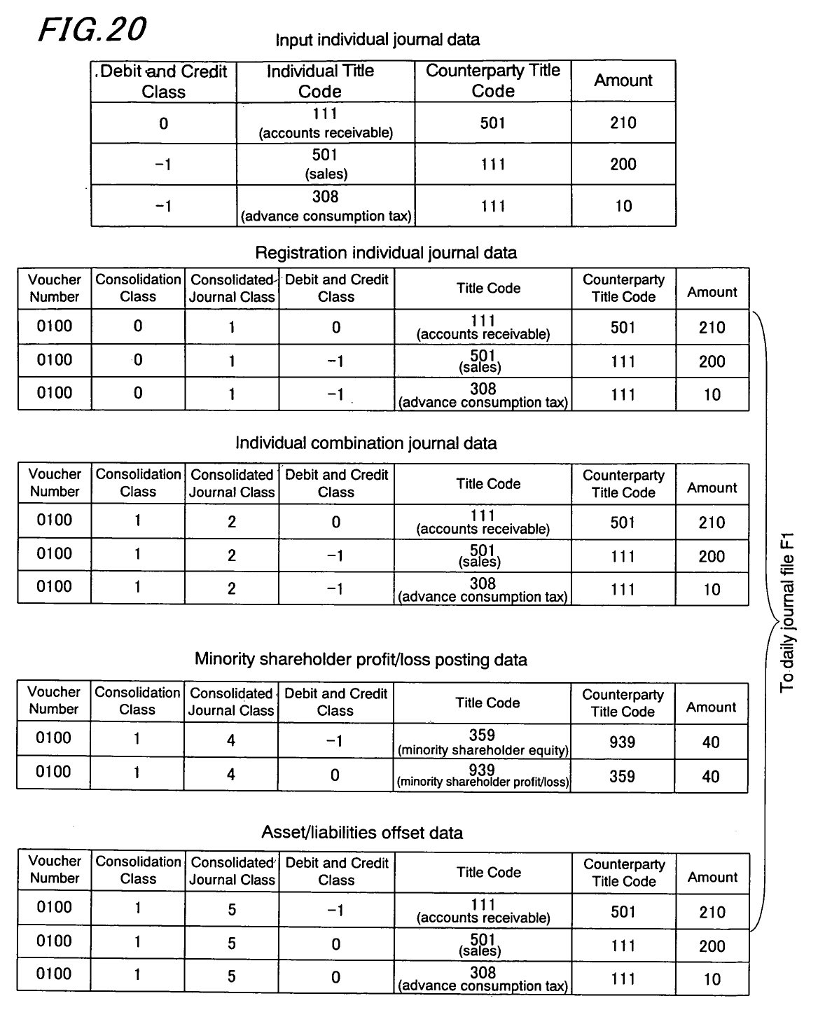

Returning to FIG. 13, processing steps S120 through to step 132 above is performed on all records of the input individual journal data corresponding to a single voucher, and after processing, processing returns to the journal main processing in FIG. 12. FIG. 20 shows a summary of the data (main items only) to be prepared by the processing in FIG. 13 for the input individual journal data of FIG. 11B corresponding to a single voucher. The equity ratio is assumed to be 0.8 (see FIG. 3).

Monthly Balance, Cash Flow Balance, Segment Balance

Update processing (steps S210, S230, S256, S286, S306) of the monthly balance, cash flow balance and segment balance that is performed in each processing is performed by balance data preparation means 28.

In the case of a monthly balance update, of the items in monthly balance file F2 shown in FIG. 10A, the consolidation class, consolidated journal class, company code, closing date, month, department code, title code, and currency code are taken as the search keys, and, on records for which these search keys match, the amount of that journal data is added to the debit amount of the record if the debit and credit class of that journal data is a debit, and the amount of the journal data is added to the credit amount of the record if the debit and credit class of that journal data is a credit.

Accordingly, if only data of a certain closing date having a specified company code that satisfies the condition “consolidation class=0” is extracted from the data in monthly balance file F2, the financial statement data required for preparing consolidated P/L sheets and consolidated balance sheets can be obtained, and individual monthly and annual financial statements for that company can be prepared.

Moreover, if data that satisfies the condition “consolidation class=1” is extracted and combined for each account title code, the financial statement data that is required for preparing consolidated P/L sheets and consolidated balance sheets can be obtained, and consolidated financial statements can be prepared. Also, if data that satisfies the condition “consolidated journal class=2” is extracted and combined for each account title code, the financial statement data that is required for preparing combined financial statements for the parent company and subsidiaries can be obtained. Furthermore, if data whose consolidated journal class=5 is extracted and combined for each account title code, intercompany transactions can be grasped.

In the case of a cash flow balance update, of the items in cash flow balance file F3 shown in FIG. 10B, the consolidation class, company code, closing date, month, department code, cash flow title code, and currency code are taken as the search keys, and, on records for which these search keys match, the amount of that journal data is added to the debit amount of the record if the debit and credit class of that journal data is a debit, and the amount of the journal data is added to the credit amount of the record if the debit and credit class of that journal data is a credit. If only data of a certain closing date having a specified company code that satisfies the condition “consolidation class=0” is extracted and specified totalization is performed, the cash flow of that company can be calculated. Totalization involves logic operations performed on cash flow from operations, cash flow from investments, and cash flow from finances in accordance with cash flow title codes based on public known cash flow calculation algorithms. Also, if data that satisfies the condition “consolidation class=1” is extracted, and logic operations are performed for each cash flow title code based on public known cash flow calculation algorithms, cash flow from operations, cash flow from investments, and cash flow from finances can be calculated in consolidated accounting.

In the case of a segment balance update, of the items in segment balance file F4 shown in FIG. 10C, the closing date, month, department code, segment title code, and currency code are taken as the search keys, and, on records for which these search keys match, the amount of that journal data is added to the debit amount of the record if the debit and credit class of that journal data is a debit, and the amount of the journal data is added to the credit amount of the record if the debit and credit class of that journal data is a credit. If only data of a certain closing date is extracted and combined for each segment for each segment title code, segment information can be prepared. In this embodiment, as segment codes and counterparty segment codes are included in the respective individual journal data, segment internal transactions, intersegment transactions, and transactions with outside companies are recognized by this from the correspondence table of the account title master shown in FIG. 6 so that segment title codes can be assigned, and, moreover, segment information can be found by calculating segment balances.

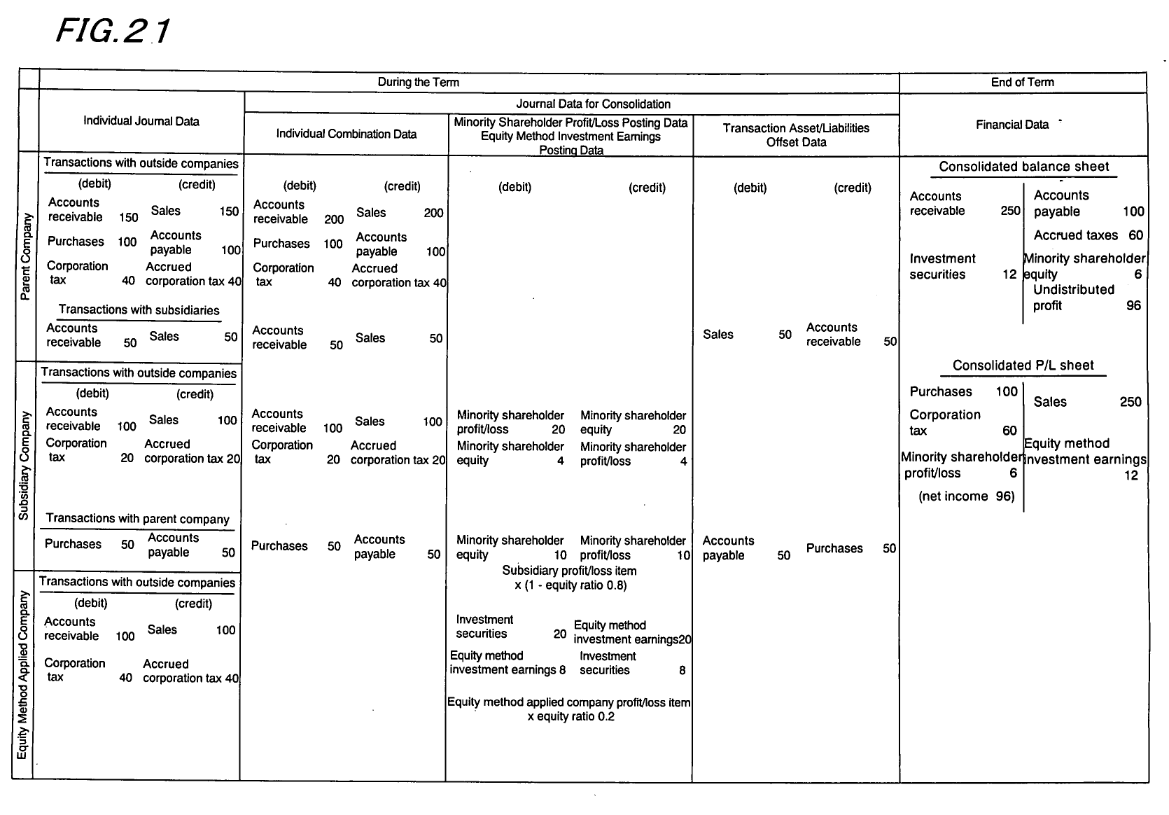

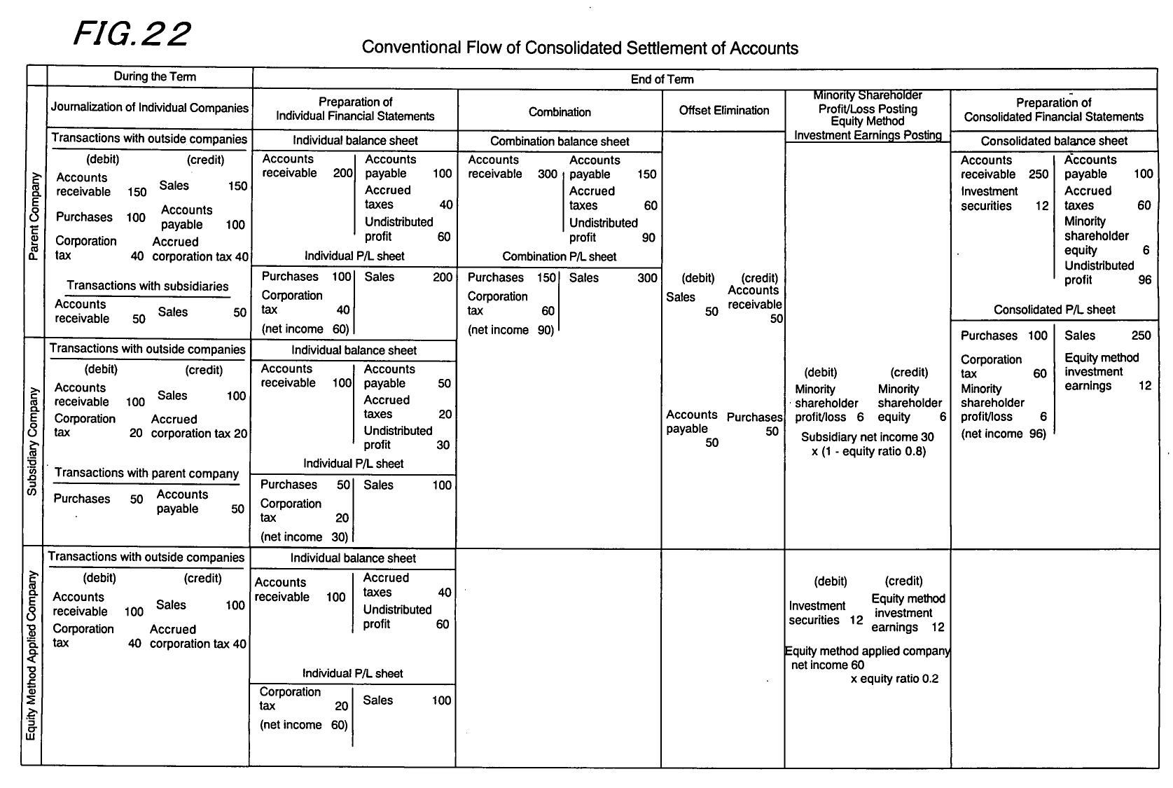

FIG. 21 shows the above processing as viewed on the entire business group. It will be understood that consolidated P/L sheets and consolidated balance sheets are prepared if journal data for consolidation comprising the individual combination data, minority shareholder profit/loss posting data and asset/liabilities offset data described above is prepared from each of the individual journal data at respective companies, and the journal data for consolidation that has been prepared is simply totalized. In a comparison with FIG. 22, it will be seen that work outside of journalization of individual companies in the example in FIG. 22 is performed entirely at year-end, whereas, in FIG. 21, consolidated financial statement data at any point in time can be obtained from journal data for consolidation that has been accumulated up to that point in time without the preparation of financial statements for individual companies.

As described above, in this embodiment, as journal data for consolidation that takes into consideration the equity ratio is prepared on the individual journal data of respective companies, accurate consolidated financial statement data at any point in time when that individual journal data has been acquired can be obtained, and accurate consolidated financial statement data can be obtained corresponding to any change in equity ratio that may occur.

While the invention has been described in terms of several preferred embodiments, those skilled in the art will recognize that the invention can be practiced with modification within the spirit and scope of the appended claims.

1. A real-time consolidated accounting system, constituted by a computer, comprising:
a storage unit configured to record equity ratio data for affiliated companies of a parent company;
a registration unit configured to register to the storage unit individual journal data of the parent company and affiliated companies that includes individually journalized dates, account title codes that enable recognition as to whether or not the code is a profit/loss item, amounts, debit and credit class, and consolidated company class data that indicates a relationship between the parent company and affiliated companies with respect to the parent company; and
a consolidated journal data preparation unit configured to judge whether or not the account title code to be included in the individual journal data of an affiliated company is a profit/loss item, and, when the account title code is a profit/loss item, to prepare and register to the storage unit journal data for consolidation that includes date, account title code, amounts, and debit and credit class, using said equity ratio data from the individual journal data of the affiliated company,
whereby financial statement data at any time of combination is obtained by using amounts that are obtained by combining said journal data for consolidation by each account title code.

2. The real-time consolidated accounting system according to claim 1, wherein the consolidated journal data preparation unit further includes an individual combination registration unit configured to prepare an individual combination journal data having unified account titles for individual combination, corresponding to the individual journal data of the parent company and affiliated companies.

3. The real-time consolidated accounting system according to claim 1, wherein the consolidated journal data preparation unit further includes a minority shareholder profit/loss posting unit configured to prepare minority shareholder profit/loss posting data that includes amount data, that is equivalent to the equity of minority shareholders with respect to individual profit/loss, corresponding to the individual journal data of a subsidiary company whose account title code is a profit/loss item.

4. The real-time consolidated accounting system according to claim 1, wherein the consolidated journal data preparation unit further includes an equity earnings posting unit configured to prepare equity earnings posting data that includes amount data, that is equivalent to the equity of the parent company with respect to individual profit/loss, corresponding to the individual journal data of an equity method applied company whose account title code is a profit/loss item.

5. The real-time consolidated accounting system according to claim 1, wherein the consolidated journal data preparation unit further includes an asset/liabilities offset unit configured to prepare asset/liabilities offset data, whose debit and credit class for offsetting intercompany transactions is reversed, corresponding to the individual journal data that indicates intercompany transactions within the business group.

6. The real-time consolidated accounting system according to claim 5, wherein said individual journal data includes consolidated company class data of counterparty, and said consolidated journal data preparation unit judges said counterparty consolidated company class is the parent company, or an affiliated company or an outside company, and prepares asset/liabilities offset data, corresponding to individual journal data whose counterparty consolidated company class is the parent company or an affiliated company.

7. The real-time consolidated accounting system according to claim 1, wherein said equity ratio data is recorded to said storage unit together with a modification history, and the equity ratio data as of that date included in the individual journal data is used for preparing journal data for consolidation.

8. A real-time consolidated accounting system, constituted by a computer, comprising:
a storage unit configured to store equity ratio data for affiliated companies of a parent company;
a registration unit configured to register to the storage unit individual journal data of the parent company and affiliated companies that includes individually journalized dates, account title codes that enable recognition as to whether or not the code is a profit/loss item, amounts, debit and credit class, and consolidated company class data that indicates a relationship between the parent company and affiliated companies with respect to the parent company;
an individual combination registration unit configured to prepare individual combination journal data having unified account titles for individual combination, corresponding to the individual journal data of the parent company and affiliated companies;
a minority shareholder profit/loss posting unit configured to prepare minority shareholder profit/loss posting data that includes amount data, that is equivalent to the equity of minority shareholders with respect to individual profit/loss, corresponding to the individual journal data of a subsidiary whose account title code is a profit/loss item;
an equity earnings posting unit configured to prepare equity earnings posting data that includes amount data, that is equivalent to the equity of the parent company with respect to individual profit/loss, corresponding to the individual journal data of an equity method applied company whose account title code is a profit/loss item; and
an asset/liabilities elimination unit configured to prepare asset/liabilities elimination data, whose debit and credit class for offsetting intercompany transactions is reversed, corresponding to the individual journal data that indicates intercompany transactions within the business group,
whereby financial statement data at any time of combination is prepared based on amounts to be obtained by combining said individual combination journal data, said minority shareholder profit/loss posting data, said equity earnings posting data, and said asset/liabilities offset data by each account title.

9. The real-time consolidated accounting system according to claim 8, wherein said individual journal data includes consolidated company class data of counterparty, said consolidated journal data preparation unit judges said counterparty consolidated company class is the parent company, or an affiliated company or an outside company, and prepares asset/liabilities offset data, corresponding to individual journal data whose counterparty consolidated company class is the parent company or an affiliated company.

10. The real-time consolidated accounting system according to claim 8, wherein equity ratio data is recorded to said storage unit together with a modification history, and the equity ratio data as of that date that is to be included in the individual journal data being used.

11. A real-time consolidated accounting program for making a computer function as
a storage means for storing equity ratio data for affiliated companies of a parent company;
a registration means for registering to the storage means individual journal data of the parent company and affiliated companies that includes individually journalized dates, account title codes that enable recognition as to whether or not the code is a profit/loss item, amounts, debit and credit class, and consolidated company class data that indicates a relationship between the parent company and affiliated companies with respect to the parent company;
an individual combination registration means for preparing individual combination journal data having unified account titles for individual combination, corresponding to the individual journal data of the parent company and affiliated companies;
a minority shareholder profit/loss posting means for preparing minority shareholder profit/loss posting data that includes amount data, that is equivalent to the equity of minority shareholders with respect to individual profit/loss, corresponding to the individual journal data of a subsidiary company whose account title code is a profit/loss item;
an equity earnings posting means for preparing equity earnings posting data that includes amount data, that is equivalent to the equity of the parent company with respect to individual profit/loss, corresponding to the individual journal data of an equity method applied company whose account title code is a profit/loss item; and
an asset/liabilities elimination means for preparing asset/liabilities elimination data, whose debit and credit class for offsetting intercompany transactions is reversed, corresponding to the individual journal data that indicates intercompany transactions within the business group,
whereby financial statement data at any time of combination is prepared based on amounts to be obtained by combining said individual combination journal data, said minority shareholder profit/loss posting data, said equity earnings posting data, and said asset/liabilities offset data by each account title.

12. A consolidated accounting method, performed using a computer, comprising
recording equity ratio data for affiliated companies of a parent company;
one of acquiring and preparing individual journal data of the parent company and affiliated companies that includes individually journalized dates, account title codes that enable recognition as to whether or not the code is a profit/loss item, amounts, debit and credit class, and consolidated company class data that indicates a relationship between the parent company and affiliated companies with respect to the parent company;
judging as to whether or not the account title code to be included in the individual journal data of an affiliated company is a profit/loss item, and, when the account title code is a profit/loss item, preparing journal data for consolidation that includes date, account title code, amounts, and debit and credit class data, using said equity ratio data from the individual journal data of the affiliated company; and
preparing financial statement data at any time of combination using amounts to be obtained by combining said journal data for consolidation by each account title code.
